(19) United States
(12) Patent Application Publication
(10) Pub. No.: US 2026/0116528 A1
(43) Pub. Date: Apr. 30, 2026

(54) PROPROTOR HUB FOR AN AIRCRAFT

(71) Applicant: Archer Aviation Inc., San Jose, CA (US)

(72) Inventor: Alan BUEHNE, Santa Ana, CA (US)

(73) Assignee: Archer Aviation Inc., San Jose, CA (US)

(21) Appl. No.: 19/205,954

(22) Filed: May 12, 2025

Related U.S. Application Data
(63) Continuation of application No. PCT/US2023/074280, filed on Sep. 15, 2023.
(60) Provisional application No. 63/407,278, filed on Sep. 16, 2022.

(51) Int. Cl. B64C 11/06; B64C 29/00

(52) U.S. Cl. CPC B64C 11/06; B64C 29/0008

(57) ABSTRACT

Conventional proprotor systems have a large region in the middle of the proprotor disk area that is occupied by the hub mounted systems including blade pitch control systems and blade retention systems. The hub-mounted systems use rotor disk area that can result in increased drag during forward flight. In one aspect herein, a proprotor assembly comprises proprotor blades that are significantly offset from the hub center.

### PRIORITY

This application claims priority to U.S. provisional application having Ser. No. 63/407,278 (filed Sep. 16, 2022). These and all other extrinsic material discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is aircraft propulsion units.

### BACKGROUND

Conventional proprotor blades extend approximately radially out from the proprotor hub. Many conventional rotors-for example helicopter rotor systems-comprise a hub structure, proprotor feather axis bearing hardware, blade retention mechanisms, and a blade pitch control system. The systems can often account for a significant portion of the size and weight of the proprotor system.

### SUMMARY

Conventional proprotor systems have a large region in the middle of the proprotor disk area that is occupied by the hub mounted systems-including blade pitch control systems and blade retention systems. The hub-mounted systems use rotor disk area that can result in increased drag during forward flight. In one aspect herein, a proprotor assembly comprises proprotor blades that are significantly offset from the hub center.

### BRIEF DESCRIPTION OF THE DRAWINGS

FIG. 1 illustrates an embodiment of a propulsion system comprising an embodiment of an offset proprotor blade hub.

FIG. 2 illustrates aspects of the same embodiment of a propulsion system as shown in FIG. 1.

FIG. 3 illustrates an alternate view of the same embodiment of an offset proprotor blade system as the embodiment of FIG. 1.

FIG. 4 illustrates a VTOL aircraft comprising an embodiment of an offset proprotor blade hub.

FIG. 5 illustrates a section view of aspects of the same embodiment of an offset proprotor blade system as the embodiment of FIG. 1.

### DETAILED DESCRIPTION

Conventional proprotor systems have a large non-thrust producing region at the center of the proprotor system. The non-thrust generating area in center of the rotor disk can increase the drag of the aircraft in forward flight. The problem is addressed in one aspect herein by a proprotor assembly in which the proprotor blade feather axis is orthogonally offset from the rotor disk center.

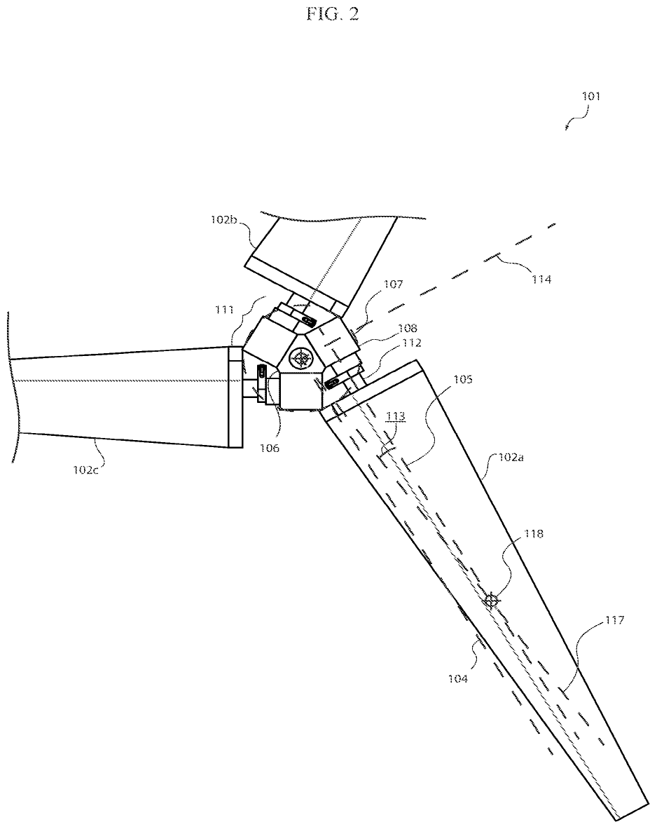

In some embodiments herein, the blade roots extend past the hub center-addressing additional desired design characteristics. In some embodiments, such as the embodiment shown in FIG. 2, the proprotor blade root 112 extends past a hub centerline axis 114 that is perpendicular to the proprotor blade feather axis 105.

Additional unexpected synergies result when concepts described herein are applied to proprotor systems comprising a compact blade retention 108 and pitch change system 111—illustrated in FIG. 2.

Conventional variable pitch rotor blades extend approximately radially out from the center of the proprotor hub-the blade feather axis approximately intersects the center of the proprotor hub.

In many conventional variable pitch proprotor systems, the layout comprises: a proprotor hub at a first, innermost, radial station; a blade pitch system at the next radial station; a blade retention system at a next radial station; and then a blade airfoil region.

Figure I illustrates an embodiment of an offset blade proprotor system 101 comprising first rotor blade 102a.

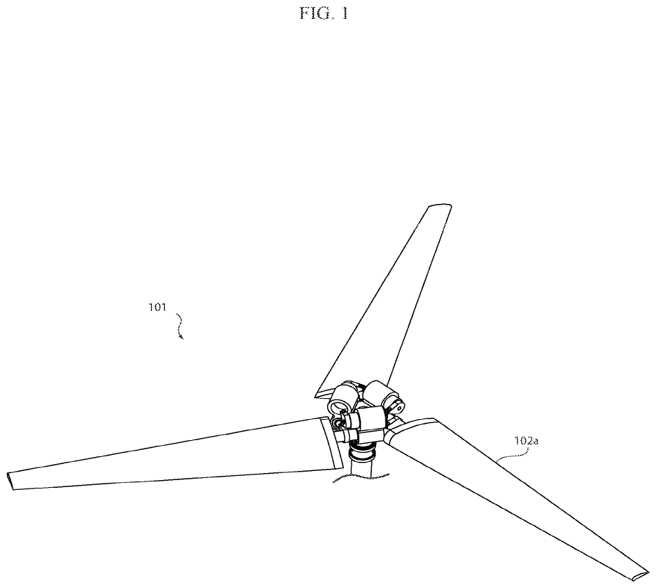

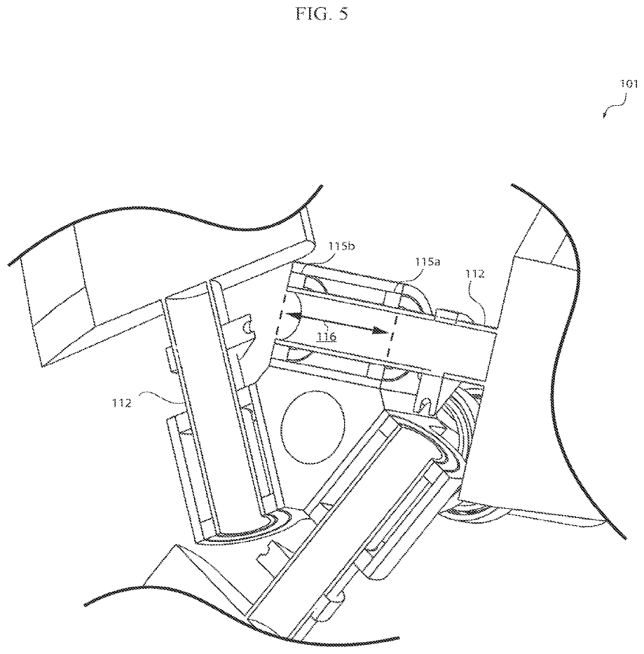

Shown in FIG. 2 is the same embodiment of an offset blade proprotor system 101 as shown in FIG. 1. Proprotor blade 102a is orthogonally offset from a proprotor hub radial 104. Unexpected synergies can be realized. The location of the proprotor blade root 112 along the side of the hub 106 can result in a smaller non-airfoil diameter 107. That is, since the proprotor blade 102a is off to the side of the main hub structure, the radial blade station taken up by the proprotor hub 106 can partially overlap with the radial blade station taken up by the proprotor blade retention system 108. Thus, the drag of the proprotor in forward flight can be decreased. In some embodiments the ratio of non-thrust generating proprotor disk 107 diameter to the feather axis bearing span distance 116 can be less than 3:1 or in some embodiments less than 4:1. In the embodiment of FIG. 5 the feather axis bearing span distance 116 is the distance between the outermost points on the outermost feather axis bearings 115a and 115b, along the proprotor blade feather axis 105.

In addition to being more compact, an offset proprotor blade hub system 101 in the embodiment of FIG. 2 can be lighter than conventional proprotor hubs. An additional positive attribute of the embodiment is that it can have less rotational inertia relative to conventional proprotor systems due to the compact and light weight system design.

Overlap between the blade root 112 and the blade retention system can provide further synergies. For proprotor systems that are neither articulated, nor hinged, the rotor blade root 112 can be along the side of the rotor hub 106. Many conventional rotor systems are hinged or articulated rotor systems. However, a proprotor system with rigid rotors can have additional synergies when the rotor blade is offset. In such an arrangement, the proprotor blade retention system 108 can be at least partially disposed alongside the rotor hub 106.

Illustrated in FIG. 2, blade retention system 108 is disposed alongside of the rotor hub 106. The embodiment of FIG. 2 comprises a rigid rotor system that is neither hinged nor articulated.

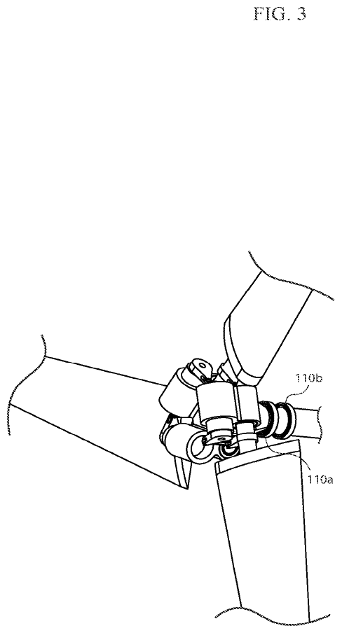

The embodiment of an offset proprotor blade hub of FIG. 2 enables the airfoil to extend very close in diameter to hub bearings 110a and 110b—illustrated in FIG. 3. The non-airfoil diameter 107 is relatively small relative to the diameter of hub bearing 110a and 110b—illustrated in FIG. 3. Because the proprotor blades 102a, 102b, and 102c are offset from the proprotor hub center 110, the pitch change system 111 and blade retention system 108 can be offset to the side of the hub 106. Unlike conventional proprotor hubs, the pitch change system does not necessitate a hub arm to extend out radially to accommodate feather axis pitch change hardware.

In the embodiment of FIG. 2, the proprotor blade feather axis 105 is offset to the side the proprotor hub 106. The blade is also angled in plane, much more than conventional proprotor blades. The proprotor blade feather axis 105 is at an angle relative to the hub center to proprotor blade center of pressure axis 117. The proprotor blade feather axis-center of pressure angle 113 is illustrated in FIG. 2. Proprotor blade center of pressure 118 is also illustrated. In some embodiments the proprotor blade feather axis-to-center of pressure angle can be larger than conventional proprotor systems. The proprotor blade feather axis-to-center of pressure angle can be larger than 10 degrees, larger than 15 degrees, larger than 20 degrees, or any other suitable angle range.

Illustrated in FIG. 2, the blade root 112 overlaps with the blade retention system 108. Thus, a first synergy between the blade root structure and pitch change system 111 can be accomplished. A second synergy can be achieved by the side of the hub 106 structure addressing the need for side support for the pitch change system 103. The embodiment of FIG. 1 thus achieves a simplistic hub structure.

As shown in FIG. 2, a desire for a very high ratio of airfoil area to total proprotor disk area can be addressed by embodiments herein-much higher than many conventional rotor systems with similar performance properties.

The offset proprotor blade hub for an aircraft as illustrated by embodiments herein address significant problems. Offset proprotor blades address the problem of minimizing the radial distance occupied only by the proprotor blade root. In the embodiment of FIG. 2, the radial distance occupied by the proprotor rotor blade root at least partially overlaps with the radial distance occupied by the hub structure.

The offset proprotor blade embodiment of FIG. 2 additionally addresses a desire to reduce propulsion system weight. The compact, and structurally efficient design can reduce the weight of the proprotor system. Another additional benefit can be an increase in the thrust producing to non-thrust producing ratio of the proprotor disk area.

In the embodiment of FIG. 1, the proprotor hub comprises composite material, and the proprotor blade retention system 108 comprises metal. However, it should be understood that any suitable materials may be used.

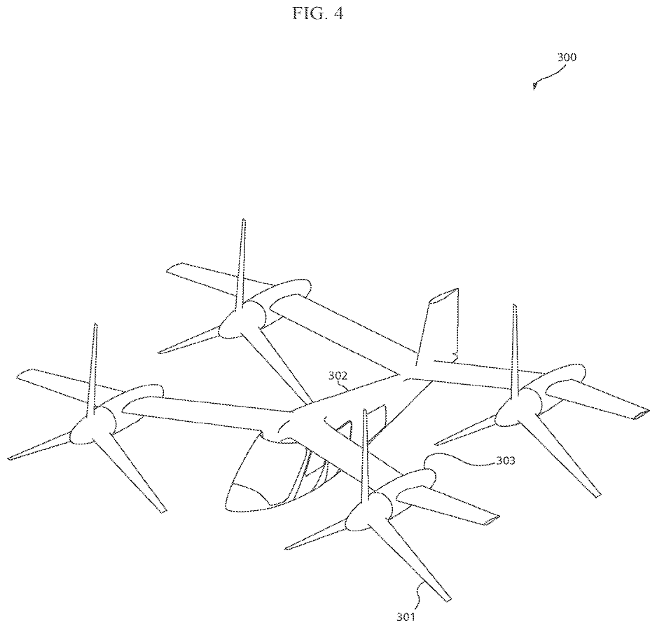

FIG. 4 illustrates aircraft 300. In the embodiment of FIG. 4, aircraft 300 comprises an electric vertical takeoff and landing (eVTOL) tiltrotor aircraft. Aircraft 300 comprises fuselage 302, nacelle 303, and an embodiment of an offset proprotor blade system 301. However, the principles described herein can be advantageously implemented in any type of aircraft including helicopters, turbine driven tiltrotors, or any other type of aircraft. Additionally, the principles described herein can be applied to other vehicles besides aircraft, for example fan boats.

It should be understood that the drawings herein are for illustrative purposes and are not to scale.

The terms proprotor is used herein for convenience. However, it should be understood that concepts herein can apply equally to rotors, propellers, proprotors, propulsors, or any other like device.

1. An aircraft comprising a proprotor comprising first and second feather axis bearings wherein a non-thrust generating proprotor disk diameter is less than three times the distance from the outside edge of the first feather axis bearing to an outside edge of the second feather axis bearing.

2. The aircraft of claim 1 wherein the proprotor comprises three proprotor blades.

3. The aircraft of claim 1 wherein the aircraft is capable of carrying more than 500 pounds of payload.

4. A proprotor system comprising a proprotor blade root comprising a proprotor blade root feather axis that is offset orthogonally from the proprotor center and that extends past a proprotor hub centerline that is perpendicular to the proprotor blade feather axis.

5. The proprotor system of claim 4 additionally comprising a feather axis bearing that is past the hub centerline.

6. A proprotor comprising a proprotor blade that comprises a proprotor feather axis, wherein an angle between the blade feather axis and a hub center to center of proprotor blade pressure line is greater than fifteen degrees.

7. The proprotor of claim 6 wherein the angle between the blade feather axis and the hub center to center of proprotor pressure line is greater than twenty degrees.

8. The proprotor of claim 6 wherein the angle between the blade feather axis and the hub center to center of proprotor pressure line is greater than thirty degrees.

9. (canceled)

10. A proprotor in which a proprotor blade are offset such that an angle between a proprotor hub to a proprotor blade center of pressure axis and a proprotor blade pitch axis is greater than ten degrees.

11. The proprotor of claim 10 comprising a second proprotor blade that is offset such that an angle between a second proprotor hub to a second proprotor blade center of pressure axis and a second proprotor blade pitch axis is greater than ten degrees.

12. The proprotor of claim 11 comprising a second proprotor blade that is offset such that an angle between a second proprotor hub to a second proprotor blade center of pressure axis and a second proprotor blade pitch axis is greater than ten degrees.

13. The proprotor of claim 10 wherein the proprotor is a rigid, non-hinged proprotor.

14. The proprotor of claim 10 wherein the proprotor is a non-articulated proprotor.
